(19) United States
(12) Patent Application Publication
(10) Pub. No.: US 2020/0040621 A1
(43) Pub. Date: Feb. 6, 2020

(54) Recessed Storage Compartment Covering Kit

(71) Applicant: Marshal Beane, Bedford, TX (US)

(72) Inventor: Marshal Beane, Bedford, TX (US)

(21) Appl. No.: 16/050,500

(22) Filed: Jul. 31, 2018

(51) Int. Cl. E05B 83/32; B60R 7/04

(52) U.S. Cl. CPC E05B 83/32; B60R 2011/0007; B60R 7/04

(57) ABSTRACT

A recessed storage compartment covering kit for a center console of a vehicle includes a plate that is rigid. A hinge is coupled by a first leaf proximate to a first end of the plate. A plurality of holes is positioned in a second leaf of the hinge. Each hole is configured to insert a respective item of mounting hardware to pivotally couple the plate to an inner surface, proximate to an upper perimeter, of a recessed compartment that is positioned in the center console. A coupler is coupled to the plate proximate to a second end of the plate. The coupler is configured to selectively couple to the center console to fixedly position the plate over the recessed compartment so that contents of the recessed compartment are retained within the recessed compartment as the center console is pivoted to a substantially vertical configuration.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to covering kits and more particularly pertains to a new covering kit for a center console of a vehicle.

### BRIEF SUMMARY OF THE INVENTION

An embodiment of the disclosure meets the needs presented above by generally comprising a plate that is rigid. A hinge is coupled by a first leaf proximate to a first end of the plate. A plurality of holes is positioned in a second leaf of the hinge. Each hole is configured to insert a respective item of mounting hardware to pivotally couple the plate to an inner surface, proximate to an upper perimeter, of a recessed compartment that is positioned in a center console of a vehicle. The plate is configured to selectively cover the recessed compartment. A coupler is coupled to the plate proximate to a second end of the plate. The coupler is configured to selectively couple to the center console to fixedly position the plate over the recessed compartment so that contents of the recessed compartment are retained within the recessed compartment as the center console is pivoted to a substantially vertical configuration.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a recessed storage compartment covering kit according to an embodiment of the disclosure.

FIG. 2 is a bottom view of an embodiment of the disclosure.

FIG. 3 is a side view of an embodiment of the disclosure.

FIG. 4 is a bottom view of an embodiment of the disclosure.

FIG. 5 is a top view of an embodiment of the disclosure.

FIG. 6 is an in-use view of an embodiment of the disclosure.

### DETAILED DESCRIPTION OF THE INVENTION

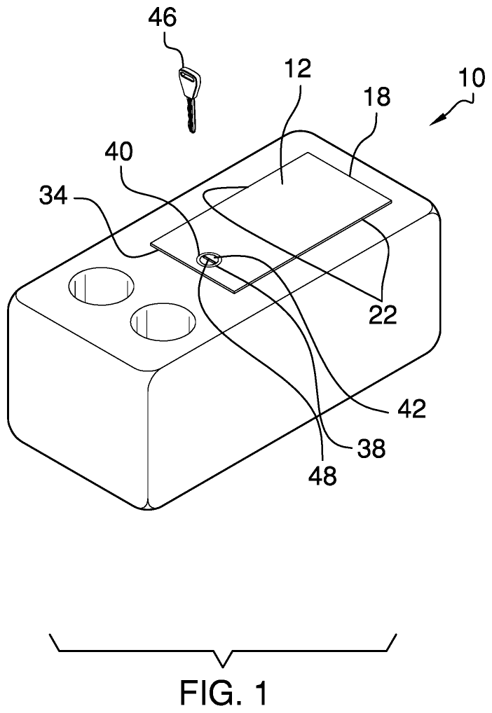

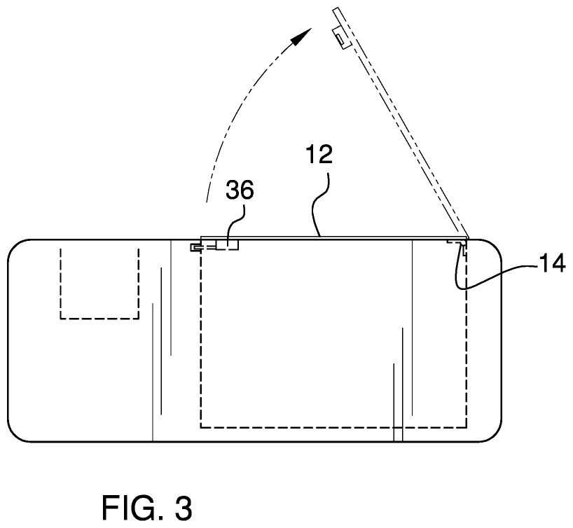

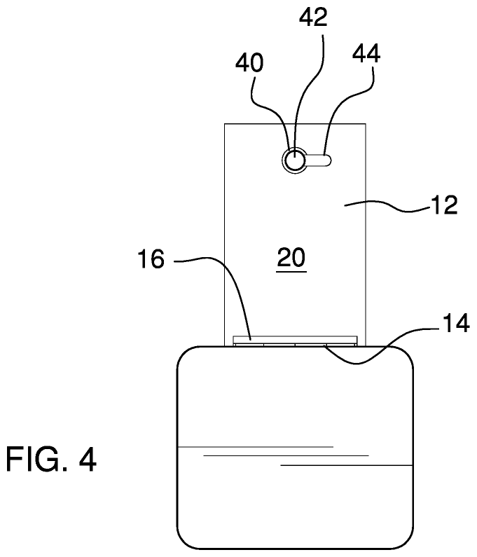

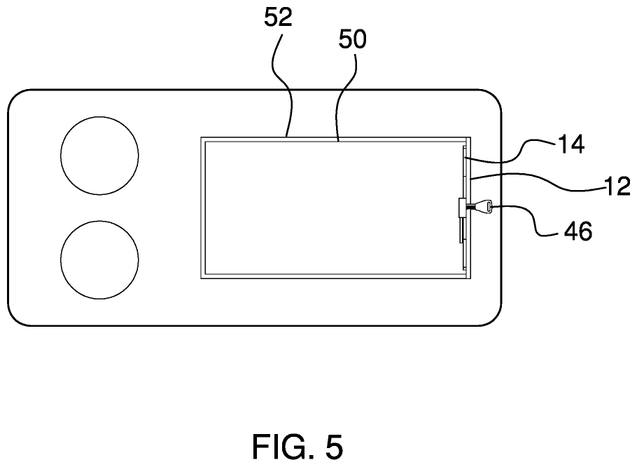

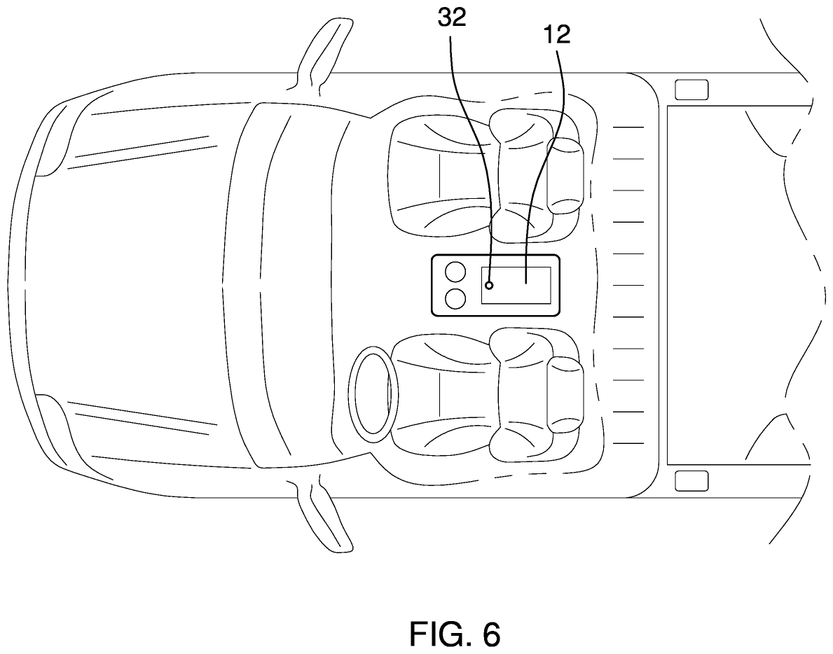

With reference now to the drawings, and in particular to FIGS. 1 through 6 thereof, a new covering kit embodying the principles and concepts of an embodiment of the disclosure and generally designated by the reference numeral 10 will be described.

As best illustrated in FIGS. 1 through 6, the recessed storage compartment covering kit 10 generally comprises a plate 12 that is rigid. The plate 12 is substantially rectangularly shaped. The plate 12 has a respective color so that the plate 12 is configured to substantially match a tint of a center console of a vehicle. The plate 12 is substantially black colored.

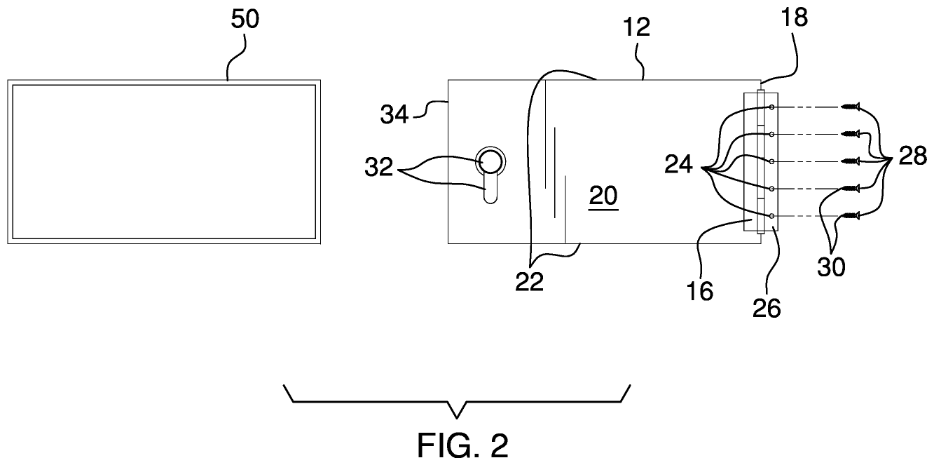

A hinge 14 is coupled by a first leaf 16 to the plate 12 proximate to a first end 18 of the plate 12, as shown in FIG. 2. The first leaf 16 is positioned on a lower face 20 of the plate 12. The first leaf 16 extends from proximate to opposing sides 22 of the plate 12.

A plurality of holes 24 is positioned in a second leaf 26 of the hinge 14. Each hole 24 is configured to insert a respective item of mounting hardware 28, such as a screw 30, to pivotally couple the plate 12 to an inner surface, proximate to an upper perimeter, of a recessed compartment that is positioned in the center console. The plate 12 is configured to selectively cover the recessed compartment. The plurality of holes 24 comprises from three to seven holes 24. The plurality of holes 24 comprises five holes 24.

The present invention anticipates the kit 10 comprising a set of screws 30 at least equivalent in number to the plurality of holes 24, as shown in FIG. 2. A user would position the second leaf 26 of the hinge 14 at an appropriate position on the inner surface of the recessed compartment, mark the positions of each hole 24, and drill a receiving hole at each position. Each screw 30 would then be inserted through a respective hole 24 and an associated receiving hole to couple the second leaf 26 to the console.

A coupler 32 is coupled to the plate 12 proximate to a second end 34 of the plate 12. The coupler 32 is configured to selectively couple to the center console to fixedly position the plate 12 over the recessed compartment so that contents of the recessed compartment are retained within the recessed compartment as the center console is pivoted from a horizontal configuration to a substantially vertical configuration. As such, the user is not required to remove the contents of the recessed compartment prior to pivoting the center console for using a space occupied by the center console in the horizontal configuration. The kit 10 is intended as an after-market accessory for use with center consoles that have a recessed compartment lacking an integral lid.

The coupler 32 comprises a cam lock 36. The cam lock 36 comprises an orifice 38 that is positioned in the plate 12. A barrel 40 is coupled to the plate 12 and extends from the lower face 20. The barrel 40 extends from the orifice 38. A core 42 positioned in and is rotatably coupled to the barrel 40. A cam 44 is coupled to and extends radially from the core 42. The user is positioned to selectively rotate the core 42 within the barrel 40 to urge the cam 44 into a cam slot that extends into the console from the recessed compartment to fixedly position the plate 12 over the recessed compartment. The user would cut the cam slot into the console at a desired location using an appropriate tool, such as a rotary cutting tool.

The kit 10 also comprises a key 46 that is complementary to a key slot 48 that is positioned in the core 42. The key slot 48 is positioned to selectively insert the key 46 to lock the core 42 to fixedly position the cam 44 within the cam slot to fixedly couple the plate 12 to the console to secure the contents of the recessed compartment.

The kit 10 also comprises a gasket 50 that is sized complementarily to the upper perimeter of the recessed compartment. If desired by the user, the gasket 50 is adhesively coupled to the console proximate to the upper perimeter of the recessed compartment. The gasket 50 is positioned to sealably couple to the plate 12 when the plate 12 is fixedly positioned over the recessed compartment. The gasket 50 is positioned such that, with the plate 12 positioned on the gasket 50, the cam 44 is aligned with the cam slot. The gasket 50 and the plate 12 work together to prevent a liquid from entering the recessed compartment. The present invention anticipates the gasket 50 having an adhesive 52 pre-applied using a technique well known to those skilled in the art of adhesives.

In use, the user rotates the core 42 of the cam lock 36 to urge the cam 44 into the cam slot to fixedly position the plate 12 over the recessed compartment. The contents of the recessed compartment are retained within the recessed compartment as the center console is pivoted from the horizontal configuration to the substantially vertical configuration.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A recessed storage compartment covering kit comprising:
a plate, the plate being rigid;
a hinge coupled by a first leaf proximate to a first end of the plate;
a plurality of holes positioned in a second leaf of the hinge wherein each hole is configured for inserting a respective item of mounting hardware for pivotally coupling the plate to an inner surface, proximate to an upper perimeter, of a recessed compartment positioned in a center console of a vehicle wherein the plate is configured for selectively covering the recessed compartment; and
a coupler coupled to the plate proximate to a second end of the plate, the coupler being configured for selectively coupling to the center console for fixedly positioning the plate over the recessed compartment such that contents of the recessed compartment are retained within the recessed compartment as the center console is pivoted from a horizontal configuration to a substantially vertical configuration.

2. The kit of claim 1, further including the plate being substantially rectangularly shaped.

3. The kit of claim 1, further including the plate having a respective color wherein the plate is configured for substantially matching a tint of the center console of the vehicle.

4. The kit of claim 3, further including the plate being substantially black colored.

5. The kit of claim 1, further including the first leaf being positioned on a lower face of the plate.

6. The kit of claim 1, further including the first leaf extending from proximate to opposing sides of the plate.

7. The kit of claim 1, further including the plurality of holes comprising from three to seven holes.

8. The kit of claim 7, further including the plurality of holes comprising five holes.

9. The kit of claim 1, further including the coupler comprising a cam lock, the cam lock comprising:
an orifice positioned in the plate;
a barrel coupled to the plate and extending from the lower face, the barrel extending from the orifice;
a core positioned in and rotatably coupled to the barrel; and
a cam coupled to and extending radially from the core positioning a user for selectively rotating the core within the barrel for urging the cam into a cam slot extending into the console from the recessed compartment for fixedly positioning the plate over the recessed compartment.

10. The kit of claim 9, further including a key complementary to a key slot positioned in the core wherein the key slot is positioned for selectively inserting the key for locking the core for fixedly positioning the cam within the cam slot for fixedly coupling the plate to the console for securing the contents of the recessed compartment.

11. The kit of claim 1, further including a gasket sized complementarily to the upper perimeter of the recessed compartment, the gasket being adhesively coupled to the console proximate to the upper perimeter of the recessed compartment wherein the gasket is positioned for sealably coupling to the plate when the plate is fixedly positioned over the recessed compartment.

12. A recessed storage compartment covering kit comprising:
a plate, the plate being rigid, the plate being substantially rectangularly shaped, the plate having a respective color wherein the plate is configured for substantially matching a tint of a center console of a vehicle, the plate being substantially black colored;
a hinge coupled by a first leaf proximate to a first end of the plate, the first leaf being positioned on a lower face of the plate, the first leaf extending from proximate to opposing sides of the plate;
a plurality of holes positioned in a second leaf of the hinge wherein each hole is configured for inserting a respective item of mounting hardware for pivotally coupling the plate to an inner surface, proximate to an upper perimeter, of a recessed compartment positioned in the center console wherein the plate is configured for selectively covering the recessed compartment, the plurality of holes comprising from three to seven holes, the plurality of holes comprising five holes;
a coupler coupled to the plate proximate to a second end of the plate, the coupler being configured for selectively coupling to the center console for fixedly positioning the plate over the recessed compartment such that contents of the recessed compartment are retained within the recessed compartment as the center console is pivoted from a horizontal configuration to a substantially vertical configuration, the coupler comprising a cam lock, the cam lock comprising:
an orifice positioned in the plate,
a barrel coupled to the plate and extending from the lower face, the barrel extending from the orifice,
a core positioned in and rotatably coupled to the barrel,
a cam coupled to and extending radially from the core positioning a user for selectively rotating the core within the barrel for urging the cam into a cam slot extending into the console from the recessed compartment for fixedly positioning the plate over the recessed compartment, and
a key complementary to a key slot positioned in the core wherein the key slot is positioned for selectively inserting the key for locking the core for fixedly positioning the cam within the cam slot for fixedly coupling the plate to the console for securing the contents of the recessed compartment; and
a gasket sized complementarily to the upper perimeter of the recessed compartment, the gasket being adhesively coupled to the console proximate to the upper perimeter of the recessed compartment wherein the gasket is positioned for sealably coupling to the plate when the plate is fixedly positioned over the recessed compartment.
